(19) United States
(12) Patent Application Publication
(10) Pub. No.: US 2026/0143525 A1
(43) Pub. Date: May 21, 2026

(54) LBT FAILURE PROCESSING METHOD, CONFIGURATION METHOD, APPARATUS, TERMINAL, AND NETWORK SIDE DEVICE

(71) Applicant: VIVO MOBILE COMMUNICATION CO., LTD., Dongguan (CN)

(72) Inventors: Jianhui LI, Dongguan (CN); Xiao XIAO, Dongguan (CN)

(73) Assignee: VIVO MOBILE COMMUNICATION CO., LTD., Dongguan (CN)

(21) Appl. No.: 19/441,843

(22) Filed: Jan. 6, 2026

Related U.S. Application Data
(63) Continuation of application No. PCT/CN2024/103892, filed on Jul. 5, 2024.

(30) Foreign Application Priority Data
Jul. 7, 2023 (CN) 202310838916.3

(51) Int. Cl. H04W 74/0808; H04W 72/231

(52) U.S. Cl. CPC H04W 74/0808; H04W 72/231

(57) ABSTRACT

A Listen Before Talk (LBT) failure processing method, a configuration method, and a resource processing method are provided. The LBT failure processing method includes: determining, by a terminal, that a Sidelink (SL) consistent LBT failure is triggered on a first transmission resource; and performing, by the terminal, a first operation. The first operation includes at least one of the following: sending first information from a Medium Access Control (MAC) layer to a Physical (PHY) layer; reporting second information to a network side device, or not reporting the second information to the network side device; or performing autonomous recovery for the first transmission resource. The first information indicates information about the first transmission resource. The second information indicates the first transmission resource on which the SL consistent LBT failure is triggered.

### CROSS-REFERENCE TO RELATED APPLICATIONS

This application is a continuation of International Application No. PCT/CN2024/103892, filed on July 5, 2024, which claims priority to Chinese Patent Application No. 202310838916.3, filed in China on July 7, 2023. The entire contents of each of the above-referenced applications are expressly incorporated herein by reference.

### TECHNICAL FIELD

This application relates to the field of communication technologies, and specifically, to an LBT failure processing method, a configuration method, an apparatus, a terminal, and a network side device.

### BACKGROUND

Due to resource contention existing on an unlicensed frequency band, a terminal may continuously detect a Listen Before Talk (LBT) failure. This means that a channel is busy in current time and may be incapable of performing normal communication. Therefore, a "sidelink consistent LBT failure (SL consistent LBT failure)" detection mechanism of the terminal is introduced in a related technology. In this case, how to perform related processing of the SL consistent LBT failure is an urgent problem.

### SUMMARY

Embodiments of this application provide an LBT failure processing method, a configuration method, an apparatus, a terminal, and a network side device.

According to a first aspect, an LBT failure processing method is provided, and is performed by a terminal. The method includes:

The terminal determines that an SL consistent LBT failure is triggered on a first transmission resource.

The terminal performs a first operation, where the first operation includes at least one of the following: sending first information from a medium access control MAC layer to a physical PHY layer, where the first information indicates information about the first transmission resource; reporting second information to a network side device, or not reporting the second information to the network side device, where the second information indicates the first transmission resource on which the SL consistent LBT failure is triggered; and performing autonomous recovery for the first transmission resource.

According to a second aspect, an information configuration method is provided, and is performed by a network side device. The method includes:

The network side device sends configuration information to a terminal, where the configuration information includes at least one of the following: first configuration information, where the first configuration information indicates whether the terminal reports, to the network side device when an SL consistent LBT failure is triggered, information used to indicate a transmission resource on which the SL consistent LBT failure is triggered; second configuration information, where the second configuration information indicates the terminal to report, to the network side device based on a first condition when the SL consistent LBT failure is triggered, information used to indicate a transmission resource on which the SL consistent LBT failure is triggered; the first condition includes at least one of the following: a quantity of transmission resources on which the SL consistent LBT failure is triggered is greater than or equal to a first value, a quantity of transmission resources on which the SL consistent LBT failure is triggered in a second transmission resource is greater than or equal to a second value, and a first ratio is greater than or equal to a third value; and the first ratio is a ratio of a transmission resource on which the SL consistent LBT failure is triggered in a third transmission resource to all transmission resources in the third transmission resource; and third configuration information, where the third configuration information indicates whether the terminal is allowed to report, to the network side device when the SL consistent LBT failure is triggered, information used to indicate a transmission resource on which the SL consistent LBT failure is triggered.

According to a third aspect, a resource processing method is provided, and is performed by a terminal. The method includes:

The terminal performs a third operation when a fifth condition is met, where the fifth condition includes at least one of the following: a ninth transmission resource is a resource included in an MCSt resource, and the MCSt resource does not include a retransmission opportunity of transmission associated with the ninth transmission resource; a ninth transmission resource is a resource included in a tenth transmission resource, the ninth transmission resource and the tenth transmission resource are resources in a same channel occupancy time period, and the tenth transmission resource does not include a retransmission opportunity of transmission associated with the ninth transmission resource; a ninth transmission resource is a resource included in an MCSt resource, and a remaining transmission resource in the MCSt resource does not include a retransmission opportunity of transmission associated with the ninth transmission resource; and a ninth transmission resource is a resource included in a tenth transmission resource, the ninth transmission resource and the tenth transmission resource are resources in a same channel occupancy time period, and a remaining transmission resource in the tenth transmission resource does not include a retransmission opportunity of transmission associated with the ninth transmission resource; and the third operation includes at least one of the following: performing resource reselection for an LBT failure of transmission associated with the ninth transmission resource; not sending third information from a PHY layer to a MAC layer, where the third information indicates to perform resource re-evaluation or resource pre-emption for the ninth transmission resource; ignoring, at the MAC layer, fourth information sent by the PHY layer, where the fourth information indicates to perform re-evaluation or pre-emption for the ninth transmission resource; and not performing re-evaluation check or pre-emption check for the ninth transmission resource at the MAC layer.

According to a fourth aspect, an LBT failure processing apparatus is provided, and is used in a terminal. The apparatus includes: a determining module, configured to determine that an SL consistent LBT failure is triggered on a first transmission resource; and a first execution module, configured to perform a first operation, where the first operation includes at least one of the following: sending first information from a medium access control MAC layer to a physical PHY layer, where the first information indicates information about the first transmission resource; reporting second information to a network side device, or not reporting the second information to the network side device, where the second information indicates the first transmission resource on which the SL consistent LBT failure is triggered; and performing autonomous recovery for the first transmission resource.

According to a fifth aspect, an information configuration apparatus is provided, and is used in a network side device. The apparatus includes: a sending module, configured to send configuration information to a terminal, where the configuration information includes at least one of the following: first configuration information, where the first configuration information indicates whether the terminal reports, to the network side device when an SL consistent LBT failure is triggered, information used to indicate a transmission resource on which the SL consistent LBT failure is triggered; second configuration information, where the second configuration information indicates the terminal to report, to the network side device based on a first condition when the SL consistent LBT failure is triggered, information used to indicate a transmission resource on which the SL consistent LBT failure is triggered; the first condition includes at least one of the following: a quantity of transmission resources on which the SL consistent LBT failure is triggered is greater than or equal to a first value, a quantity of transmission resources on which the SL consistent LBT failure is triggered in a second transmission resource is greater than or equal to a second value, and a first ratio is greater than or equal to a third value; and the first ratio is a ratio of a transmission resource on which the SL consistent LBT failure is triggered in a third transmission resource to all transmission resources in the third transmission resource; and third configuration information, where the third configuration information indicates whether the terminal is allowed to report, to the network side device when the SL consistent LBT failure is triggered, information used to indicate a transmission resource on which the SL consistent LBT failure is triggered.

According to a sixth aspect, a resource processing apparatus is provided, and is used in a terminal. The apparatus includes: a second execution module, configured to perform a third operation when a fifth condition is met, where the fifth condition includes at least one of the following: a ninth transmission resource is a resource in an MCSt resource, and the MCSt resource does not include a retransmission opportunity of transmission associated with the ninth transmission resource; a ninth transmission resource is a resource included in a tenth transmission resource, the ninth transmission resource and the tenth transmission resource are resources in a same channel occupancy time period, and the tenth transmission resource does not include a retransmission opportunity of transmission associated with the ninth transmission resource; a ninth transmission resource is a resource included in an MCSt resource, and a remaining transmission resource in the MCSt resource does not include a retransmission opportunity of transmission associated with the ninth transmission resource; and a ninth transmission resource is a resource included in a tenth transmission resource, the ninth transmission resource and the tenth transmission resource are resources in a same channel occupancy time period, and a remaining transmission resource in the tenth transmission resource does not include a retransmission opportunity of transmission associated with the ninth transmission resource; and the third operation includes at least one of the following: performing resource reselection for an LBT failure of transmission associated with the ninth transmission resource; not sending third information from a PHY layer to a MAC layer, where the third information indicates to perform resource re-evaluation or resource pre-emption for the ninth transmission resource; ignoring, at the MAC layer, fourth information sent by the PHY layer, where the fourth information indicates to perform re-evaluation or pre-emption for the ninth transmission resource; and not performing re-evaluation check or pre-emption check for the ninth transmission resource at the MAC layer.

According to a seventh aspect, a terminal is provided. The terminal includes a processor and a memory, and the memory stores a program or an instruction that can be run on the processor; and when the program or the instruction is executed by the processor, the steps of the method according to the first aspect are implemented, or the steps of the method according to the third aspect are implemented.

According to an eighth aspect, a terminal is provided. The terminal includes a processor and a communication interface. The processor is configured to: determine that an SL consistent LBT failure is triggered on a first transmission resource; and perform a first operation, where the first operation includes at least one of the following: sending first information from a MAC layer to a PHY layer, where the first information indicates information about the first transmission resource; reporting second information to a network side device, or not reporting the second information to the network side device, where the second information indicates the first transmission resource on which the SL consistent LBT failure is triggered; and performing autonomous recovery for the first transmission resource.

According to a ninth aspect, a terminal is provided. The terminal includes a processor and a communication interface. The processor is configured to perform a third operation when a fifth condition is met, where the fifth condition includes at least one of the following: a ninth transmission resource is a resource included in an MCSt resource, and the MCSt resource does not include a retransmission opportunity of transmission associated with the ninth transmission resource; a ninth transmission resource is a resource included in a tenth transmission resource, the ninth transmission resource and the tenth transmission resource are resources in a same channel occupancy time period, and the tenth transmission resource does not include a retransmission opportunity of transmission associated with the ninth transmission resource; a ninth transmission resource is a resource included in an MCSt resource, and a remaining transmission resource in the MCSt resource does not include a retransmission opportunity of transmission associated with the ninth transmission resource; and a ninth transmission resource is a resource included in a tenth transmission resource, the ninth transmission resource and the tenth transmission resource are resources in a same channel occupancy time period, and a remaining transmission resource in the tenth transmission resource does not include a retransmission opportunity of transmission associated with the ninth transmission resource; and the third operation includes at least one of the following: performing resource reselection for an LBT failure of transmission associated with the ninth transmission resource; not sending third information from a PHY layer to a MAC layer, where the third information indicates to perform resource re-evaluation or resource pre-emption for the ninth transmission resource; ignoring, at the MAC layer, fourth information sent by the PHY layer, where the fourth information indicates to perform re-evaluation or pre-emption for the ninth transmission resource; and not performing re-evaluation check or pre-emption check for the ninth transmission resource at the MAC layer.

According to a tenth aspect, a network side device is provided. The network side device includes a processor and a memory, and the memory stores a program or an instruction that can be run on the processor; and when the program or the instruction is executed by the processor, the steps of the method according to the second aspect are implemented.

According to an eleventh aspect, a network side device is provided. The network side device includes a processor and a communication interface. The communication interface is configured to send configuration information to a terminal, where the configuration information includes at least one of the following: first configuration information, where the first configuration information indicates whether the terminal reports, to the network side device when an SL consistent LBT failure is triggered, information used to indicate a transmission resource on which the SL consistent LBT failure is triggered; second configuration information, where the second configuration information indicates the terminal to report, to the network side device based on a first condition when the SL consistent LBT failure is triggered, information used to indicate a transmission resource on which the SL consistent LBT failure is triggered; the first condition includes at least one of the following: a quantity of transmission resources on which the SL consistent LBT failure is triggered is greater than or equal to a first value, a quantity of transmission resources on which the SL consistent LBT failure is triggered in a second transmission resource is greater than or equal to a second value, and a first ratio is greater than or equal to a third value; and the first ratio is a ratio of a transmission resource on which the SL consistent LBT failure is triggered in a third transmission resource to all transmission resources in the third transmission resource; and third configuration information, where the third configuration information indicates whether the terminal is allowed to report, to the network side device when the SL consistent LBT failure is triggered, information used to indicate a transmission resource on which the SL consistent LBT failure is triggered.

According to a twelfth aspect, a readable storage medium is provided. The readable storage medium stores a program or an instruction; and when the program or the instruction is executed by a processor, the steps of the method according to the first aspect are implemented, or the steps of the method according to the second aspect are implemented, or the steps of the method according to the third aspect are implemented.

According to a thirteenth aspect, a wireless communication system is provided. The wireless communication system includes a terminal and a network side device. The terminal may be configured to perform the steps of the method according to the first aspect or the third aspect, and the network side device may be configured to perform the steps of the method according to the second aspect.

According to a fourteenth aspect, a chip is provided. The chip includes a processor and a communication interface. The communication interface is coupled to the processor. The processor is configured to run a program or an instruction, to implement the steps of the method according to the first aspect, or implement the steps of the method according to the second aspect, or implement the steps of the method according to the third aspect.

According to a fifteenth aspect, a computer program/program product is provided. The computer program/program product is stored in a storage medium, and the computer program/program product is executed by at least one processor, to implement the steps of the method according to the first aspect, or implement the steps of the method according to the second aspect, or implement the steps of the method according to the third aspect.

In embodiments of this application, after determining that the SL consistent LBT failure is triggered on the first transmission resource, the terminal may perform the first operation, where the first operation includes at least one of the following: sending the first information from the MAC layer to the PHY layer, where the first information indicates the information about the first transmission resource; reporting the second information to the network side device, or not reporting the second information to the network side device, where the second information indicates the first transmission resource on which the SL consistent LBT failure is triggered; and performing autonomous recovery for the first transmission resource. Therefore, how to perform related processing of the SL consistent LBT failure can be specified, thereby improving transmission efficiency on an SL unlicensed frequency band.

### BRIEF DESCRIPTION OF DRAWINGS

FIG. 1 is a block diagram of a wireless communication system to which embodiments of this application are applicable;

FIG. 2 is a flowchart of an LBT failure processing method according to an embodiment of this application;

FIG. 3 is a flowchart of an information configuration method according to an embodiment of this application;

FIG. 4 is a flowchart of a resource processing method according to an embodiment of this application;

FIG. 5 is a schematic diagram of a structure of an LBT failure processing apparatus according to an embodiment of this application;

FIG. 6 is a schematic diagram of a structure of an information configuration apparatus according to an embodiment of this application;

FIG. 7 is a schematic diagram of a structure of a resource processing apparatus according to an embodiment of this application;

FIG. 8 is a schematic diagram of a structure of a communication device according to an embodiment of this application;

FIG. 9 is a schematic diagram of a structure of a terminal according to an embodiment of this application; and

FIG. 10 is a schematic diagram of a structure of a network side device according to an embodiment of this application.

### DETAILED DESCRIPTION

The following clearly describes the technical solutions in embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms "first", "second", and the like in this application are used to distinguish between similar objects, instead of describing a specific order or sequence. It should be understood that the terms used in such a way are interchangeable in proper circumstances, so that the embodiments of this application can be implemented in an order other than the order illustrated or described herein. Objects classified by "first" and "second" are usually of a same type, and a quantity of objects is not limited. For example, there may be one or more first objects. In addition, "or" in this application represents at least one of connected objects. For example, "A or B" covers three solutions. For example, in a solution 1, A is included but B is not included; in a solution 2, B is included but A is not included; and in a solution 3, both A and B are included. The character "/" usually indicates an "or" relationship between associated objects.

The term "indication" in this application may be either a direct indication (or an explicit indication) or an indirect indication (or an implicit indication). The direct indication may be understood as that a sender explicitly notifies a receiver of content such as information, an operation that needs to be performed, or a request result in a sent indication. The indirect indication may be understood as that the receiver determines corresponding information based on an indication sent by the sender, or performs determining and determines an operation that needs to be performed, a request result, or the like based on a determining result.

It should be noted that the technologies described in the embodiments of this application are not limited to a Long Term Evolution (LTE)/LTE-Advanced (LTE-A) system, and may also be used in other wireless communication systems such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-Carrier Frequency Division Multiple Access (SC-FDMA) system, or another system. The terms "system" and "network" in the embodiments of this application may be used interchangeably. The technologies described can be applied to both the systems and the radio technologies mentioned above as well as to other systems and radio technologies. A New Radio (NR) system is described in the following descriptions for illustrative purposes, and the NR terminology is used in most of the following descriptions, although these technologies can also be applied to a system other than the NR system, for example, a 6^{th} Generation (6G) communication system.

FIG. 1 is a block diagram of a wireless communication system to which embodiments of this application are applicable. The wireless communication system includes a terminal 11 and a network side device 12. The terminal 11 may be a terminal side device, for example, a mobile phone, a tablet personal computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR) device, a Virtual Reality (VR) device, a robot, a wearable device, a flight vehicle, a Vehicle User Equipment (VUE), a maritime user equipment, a Pedestrian User Equipment (PUE), a smart home (a home device having a wireless communication function, for example, a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart anklet chain, and the like), a smart wrist strap, smart clothes, and the like. A vehicle-mounted device may also be referred to as a vehicle-mounted terminal, a vehicle-mounted controller, a vehicle-mounted module, a vehicle-mounted component, a vehicle-mounted chip, or a vehicle-mounted unit. It should be noted that a specific type of the terminal 11 is not limited in the embodiments of this application. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (Wi-Fi) node, or the like. The base station may be referred to as a NodeB (NB), an Evolved NodeB (eNB), a next generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), aHome (HNB), a home evolved NodeB, a Transmission Reception Point (TRP), or another appropriate term in the field. Provided that same technical effect is achieved, the base station is not limited to a specified technical term. It should be noted that in the embodiments of this application, only a base station in an NR system is used as an example for description, and a type of the base station is not limited.

To better understand the embodiments of this application, the following content is first described.

Sidelink (SL) transmission is data transmission performed between terminals such as User Equipments (UEs) at a physical layer. The sidelink may also be referred to as a secondary link, a side link, an edge link, or the like.

In a communication system, an unlicensed band may serve as a supplement to a licensed band to help an operator perform service capacity expansion. For an unlicensed frequency band, LBT may be used to occupy a transmission resource. Types of the LBT may be classified into Type1, Type2A, Type2B, and Type2C. Type1 LBT is a channel listening mechanism based on back-off. When a transmission node detects that the channel is busy, back-off is performed and listening is performed until it is detected that the channel is idle. Type2C means that the transmission node does not perform LBT, that is, no LBT or immediate transmission. Type2A LBT and Type2B LBT are one-shot LBT. That is, the transmission node performs LBT once before transmission, and performs transmission if the channel is idle, or does not perform transmission if the channel is busy. A difference between Type2A LBT and Type2B LBT is as follows: Type2A LBT is performed within 25 μs, which is applicable to a case that a gap between two transmissions is greater than or equal to 25 microseconds (μs) when Channel Occupancy Time (COT) is shared; and Type2B LBT is performed within 16 μs, which is applicable to a case that a gap between two transmissions is greater than or equal to 16 μs when COT is shared. In addition, the types of the LBT further include Type2. Type2 LBT is applicable to Licensed Assisted Access (LAA)/enhanced Licensed Assisted Access (eLAA)/Further enhanced Licensed Assisted Access (FeLAA) or the like. When the COT is shared and the gap between the two transmissions is greater than or equal to 25 μs, the eNB and the UE may use Type 2 LBT. In addition, types of the LBT are further classified into Type1, Type2, and Type3. Type1 is a channel listening mechanism based on back-off. Type 2 is one-shot LBT mechanism. LBT of 5 μs is performed within 8 μs. Type 3 does not perform LBT.

With reference to the accompanying drawings, the following describes in detail, by using some embodiments and application scenarios thereof, an LBT failure processing method, a configuration method, an apparatus, a terminal, and a network side device provided in the embodiments of this application.

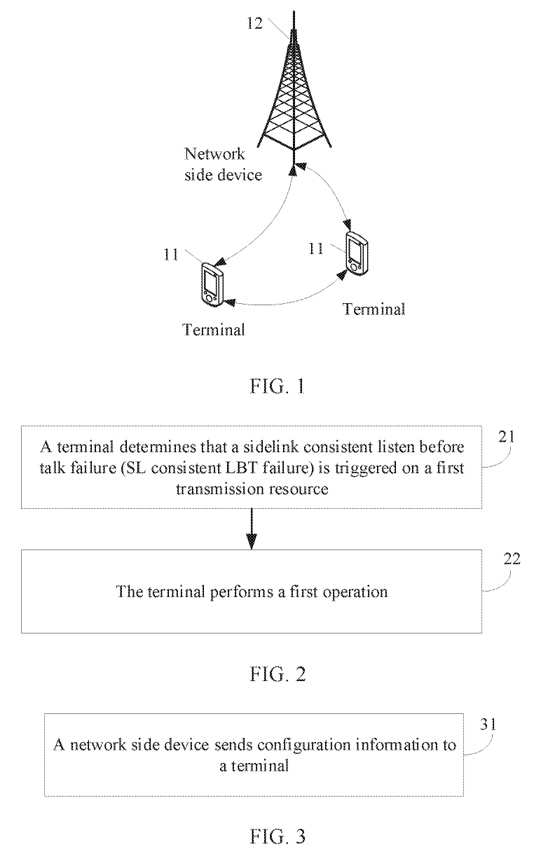

FIG. 2 is a flowchart of an LBT failure processing method according to an embodiment of this application. The method is performed by a terminal. As shown in FIG. 2, the method includes the following steps.

Step 11: The terminal determines that an SL consistent LBT failure is triggered on a first transmission resource.

Step 12: The terminal performs a first operation.

Herein, that the SL consistent LBT failure is triggered on the first transmission resource may be understood as that the SL consistent LBT failure occurs on the first transmission resource.

In some embodiments, the first operation includes at least one of the following: sending first information from a Medium Access Control (MAC) layer to a Physical (PHY) layer, where the first information indicates information about the first transmission resource; reporting second information to a network side device, or not reporting the second information to the network side device, where the second information indicates the first transmission resource on which the SL consistent LBT failure is triggered, and for example, the second information may be selected as a Medium Access Control Control Element (MAC CE); and performing autonomous recovery for the first transmission resource.

Therefore, how to perform related processing of the SL consistent LBT failure can be specified, thereby improving transmission efficiency on an SL unlicensed frequency band.

In some embodiments, the information about the first transmission resource includes but is not limited to a granularity of the first transmission resource, and the like. The granularity of the first transmission resource may be selected as at least one of the following: a Resource Block set (RB set), a resource pool, a Bandwidth Part (BWP), a carrier, and the like. For example, one carrier may include only one BWP; and one BWP may include one or more resource pools, and one resource pool may include one or more RB sets.

In this embodiment of this application, when the terminal performs SL transmission by using the first transmission resource, the granularity of the first transmission resource may be an RB set, a resource pool, a BWP, or a carrier. The RB set is used as an example. When the terminal determines/judges that the SL consistent LBT failure is triggered/occurs in the RB set, the MAC layer may notify the PHY layer of information about the RB set. After receiving the notification, the PHY layer may learn that a channel access success rate of the RB set is not high, so that the RB set can be excluded during resource selection.

In some embodiments, when the terminal performs LBT for a transmission opportunity of a Sidelink Synchronization Signal Block (S-SSB) or a Physical Sidelink Feedback Channel (PSFCH), LBT failures are also counted, that is, they are used to determine whether the SL consistent LBT failure occurs in the RB set used for S-SSB or PSFCH transmission. However, because the SL consistent LBT failure may not affect the terminal to perform S-SSB or PSFCH transmission by using the RB set in which the SL consistent LBT failure is triggered, when the SL consistent LBT failure is triggered in the RB set, if subsequent transmission of the terminal does not involve transmission of a Physical Sidelink Shared Channel (PSSCH) or a Physical Sidelink Control Channel (PSCCH), the MAC layer may not indicate, to the PHY layer, information about the RB set in which the SL consistent LBT failure occurs. In view of this, it may be considered to optimize the information about the RB set when the MAC layer notifies the PHY layer that the SL consistent LBT failure is triggered/occurs, to reduce signaling overheads.

In some embodiments, the sending first information from a MAC layer to a PHY layer may include at least one of the following: when the terminal triggers resource selection or reselection, sending the first information from the MAC layer to the PHY layer; and sending the first information from the MAC layer to the PHY layer for each resource selection process or resource reselection process.

In this way, the MAC layer may not send the first information to the PHY layer without affecting subsequent transmission, thereby reducing signaling overheads.

For an SL UE in a Radio Resource Control (RRC) connected state, when determining that the SL consistent LBT failure is triggered/occurs in the RB set, the SL UE may report an SL LBT failure MAC CE to a base station, that is, report the SL consistent LBT failure that is triggered/occurs in the RB set. Based on whether a UE is in a connected state and a resource allocation mode, SL UEs may be classified into three types: a mode-1 UE (in an RRC connected state herein), a connected state mode-2 UE, and an idle /INACTIVE mode-2 UE. A transmission resource of the mode-1 UE is scheduled by the base station. When it is determined that the SL consistent LBT failure occurs in the RB set, the mode-1 UE can recover the transmission resource only by relying on a configuration of the base station. Therefore, when the SL consistent LBT failure occurs in the mode-1 UE, resource recovery can be performed only in a manner of reporting the SL LBT failure MAC CE to the base station. However, because the IDLE/INACTIVE mode-2 UE does not establish an RRC connection to the base station, when determining that the SL consistent LBT failure is triggered/occurs in the RB set, the IDLE/INACTIVE mode-2 UE can only determine, by itself, whether the transmission resource is recovered, for example, determine, based on a condition such as a timer/measurement/successful transmission, whether the transmission resource is recovered. The INACTIVE mode-2 UE may perform resource recovery through both the base station and the INACTIVE mode-2 UE itself. Therefore, for the INACTIVE mode-2 UE, a behavior of reporting the SL LBT failure MAC CE may be determined based on a network configuration.

In some embodiments, when determining that the SL consistent LBT failure is triggered on the first transmission resource, the terminal may or may not report the second information to the network side device based on the configuration. The LBT failure processing method may further include:

The terminal receives configuration information, where the configuration information includes at least one of the following: first configuration information, where the first configuration information indicates whether the terminal reports, to the network side device when the SL consistent LBT failure is triggered, information used to indicate a transmission resource on which the SL consistent LBT failure is triggered; second configuration information, where the second configuration information indicates the terminal to report, to the network side device based on a first condition when the SL consistent LBT failure is triggered, information used to indicate a transmission resource on which the SL consistent LBT failure is triggered; the first condition includes at least one of the following: a quantity of transmission resources on which the SL consistent LBT failure is triggered is greater than or equal to a first value, a quantity of transmission resources on which the SL consistent LBT failure is triggered in a second transmission resource is greater than or equal to a second value, and a first ratio is greater than or equal to a third value; and the first ratio is a ratio of a transmission resource on which the SL consistent LBT failure is triggered in a third transmission resource to all transmission resources in the third transmission resource; and third configuration information, where the third configuration information indicates whether the terminal is allowed to report, to the network side device when the SL consistent LBT failure is triggered, information used to indicate a transmission resource on which the SL consistent LBT failure is triggered. Whether the information used to indicate the transmission resource on which the SL consistent LBT failure is triggered is allowed to be reported to the network side device may be understood as whether the information used to indicate the transmission resource on which the SL consistent LBT failure is triggered may be reported to the network side device.

Herein, the terminal may receive the configuration information from the network side device. The first value, the second value, and the third value may be configured by the network side device, pre-agreed, protocol-stipulated, or the like. This is not limited.

In some embodiments, when the terminal does not receive the configuration information, the terminal does not report the second information to the network side device, that is, does not indicate, to the network side device, the first transmission resource on which the SL consistent LBT failure is triggered.

In some embodiments, when the configuration information includes the first configuration information, the reporting second information to a network side device, or not reporting the second information to the network side device may include:

The terminal reports the second information to the network side device when the first configuration information indicates the terminal to report, to the network side device when the SL consistent LBT failure is triggered, the information used to indicate the transmission resource on which the SL consistent LBT failure is triggered; or the terminal does not report the second information to the network side device when the first configuration information indicates the terminal to not report, to the network side device when the SL consistent LBT failure is triggered, the information used to indicate the transmission resource on which the SL consistent LBT failure is triggered.

For example, assuming that the UE receives first configuration information of the base station, where the first configuration information indicates whether the UE reports, to the base station when the SL consistent LBT failure is triggered, a MAC CE used to indicate a transmission resource on which the SL consistent LBT failure is triggered, when the UE determines/judges that the SL consistent LBT failure is triggered on the first transmission resource, if the first configuration information indicates the UE to report, to the base station when the SL consistent LBT failure is triggered, the MAC CE used to indicate the transmission resource on which the SL consistent LBT failure is triggered, the UE reports a first MAC CE to the base station; or if the first configuration information indicates the UE not to report, to the base station when the SL consistent LBT failure is triggered, the MAC CE used to indicate the transmission resource on which the SL consistent LBT failure is triggered, the UE does not report the first MAC CE to the base station; and the first MAC CE indicates the first transmission resource on which the SL consistent LBT failure is triggered. In addition, if the UE does not receive the first configuration information of the base station, when determining/conforming that the SL consistent LBT failure is triggered on the first transmission resource, the UE does not report the first MAC CE to the base station.

In some embodiments, when the configuration information includes the second configuration information, the reporting second information to a network side device, or not reporting the second information to the network side device may include:

The terminal reports the second information to the network side device when the first transmission resource meets the first condition; or the terminal does not report the second information to the network side device when the first transmission resource does not meet the first condition.

For example, assuming that the UE receives second configuration information of the base station, where the second configuration information indicates the UE to report, to the base station based on the first condition when the SL consistent LBT failure is triggered, a MAC CE used to indicate a transmission resource on which the SL consistent LBT failure is triggered; and the first condition includes at least one of the following: -the quantity of transmission resources on which the SL consistent LBT failure is triggered is greater than N, the granularity of the transmission resource may be an RB set, a resource pool, a BWP, or a carrier, and N may be configured by the base station, protocol-stipulated, or the like; -the quantity of transmission resources on which the SL consistent LBT failure is triggered in the second transmission resource is greater than or equal to M; a granularity of the second transmission resource is greater than the granularity of the transmission resource on which the SL consistent LBT failure is triggered, and for example, the granularity of the second transmission resource is a resource pool, and therefore the granularity of the transmission resource on which the SL consistent LBT failure is triggered is an RB set; and M may be configured by the base station, protocol-stipulated, or the like; and -the ratio of the transmission resource on which the SL consistent LBT failure is triggered in the third transmission resource to all of the transmission resources in the third transmission resource is greater than or equal to Q%; the granularity of the second transmission resource is greater than the granularity of the transmission resource on which the SL consistent LBT failure is triggered, and for example, the granularity of the second transmission resource is a resource pool, and the granularity of the transmission resource on which the SL consistent LBT failure is triggered is an RB set; and Q may be configured by the base station, protocol-stipulated, or the like, when the UE determines/judges that the SL consistent LBT failure is triggered on the first transmission resource, if the first condition is met, the UE reports the first MAC CE to the base station; or if the first condition is not met, the UE does not report the first MAC CE to the base station; and the first MAC CE indicates the first transmission resource on which the SL consistent LBT failure is triggered. In addition, if the UE does not receive the second configuration information of the base station, when determining/conforming that the SL consistent LBT failure is triggered on the first transmission resource, the UE does not report the first MAC CE to the base station.

In some embodiments, when the configuration information includes the third configuration information, the reporting second information to a network side device, or not reporting the second information to the network side device may include:

The terminal reports, based on an implementation of the terminal, the second information to the network side device, or does not report the second information to the network side device when the third configuration information indicates that the terminal is allowed to report, to the network side device when the SL consistent LBT failure is triggered, the information used to indicate the transmission resource on which the SL consistent LBT failure is triggered; or the terminal does not report the second information to the network side device when the third configuration information indicates that the terminal is not allowed to report, to the network side device when the SL consistent LBT failure is triggered, the information used to indicate the transmission resource on which the SL consistent LBT failure is triggered.

For example, assuming that the UE receives third configuration information of the base station, where the third configuration information indicates whether the UE is allowed to/may report, to the base station when the SL consistent LBT failure is triggered, a MAC CE used to indicate a transmission resource on which the SL consistent LBT failure is triggered, when the UE determines/judges that the SL consistent LBT failure is triggered on the first transmission resource, if the third configuration information indicates that the UE is allowed to/may report, to the base station when the SL consistent LBT failure is triggered, the MAC CE used to indicate the transmission resource on which the SL consistent LBT failure is triggered, the UE decide, based on an implementation of the UE, to report a first MAC CE to the base station; or if the third configuration information indicates that the UE is not allowed to/may not report, to the base station when the SL consistent LBT failure is triggered, the MAC CE used to indicate the transmission resource on which the SL consistent LBT failure is triggered, the UE does not report the first MAC CE to the base station; and the first MAC CE indicates the first transmission resource on which the SL consistent LBT failure is triggered. In addition, if the UE does not receive the third configuration information of the base station, when determining/conforming that the SL consistent LBT failure is triggered on the first transmission resource, the UE does not report the first MAC CE to the base station.

It should be noted that for the foregoing embodiment, when the UE does not report the first MAC CE to the base station, for the first transmission resource, the UE may perform resource autonomous recovery based on the timer/measurement/successful transmission or the like.

For the mode-2 UE, when determining/conforming that the SL consistent LBT failure occurs on the transmission resource, the mode-2 UE may perform resource autonomous recovery in a manner such as the timer/measurement/successful transmission, that is, autonomously determine whether the transmission resource on which the SL consistent LBT failure occurs is recovered and available. For example, when determining that the SL consistent LBT failure occurs on a transmission resource, the UE may start a first timer. When the first timer expires, the UE determines that the transmission resource is recovered from the SL consistent LBT failure. For another example, when determining that the SL consistent LBT failure occurs on a transmission resource, the UE may measure the transmission resource, and calculate a resource occupancy ratio. When the resource occupancy ratio of the transmission resource is lower than a preset threshold, the UE determines that the transmission resource is recovered from the SL consistent LBT failure. For another example, when the UE determines that the SL consistent LBT failure occurs on a transmission resource, if the UE successfully performs sidelink SL transmission, the UE may determine that the transmission resource is recovered from the SL consistent LBT failure.

In some embodiments, the performing autonomous recovery for the first transmission resource may include:

The terminal starts a first timer; and when the first timer is running, if a second condition is met, stops the first timer, and determines that the first transmission resource is recovered from the SL consistent LBT failure, or cancels the SL consistent LBT failure for the first transmission resource, where the second condition includes at least one of the following: the terminal successfully performs sidelink transmission, a channel occupancy ratio of the first transmission resource is less than or equal to a fourth value, a resource occupancy ratio of the first transmission resource is less than or equal to a fifth value, a channel occupancy ratio of a fourth transmission resource that includes the first transmission resource is less than or equal to a sixth value, a resource occupancy ratio of a fifth transmission resource that includes the first transmission resource is less than or equal to a seventh value, the terminal reports the second information to the network side device, the first transmission resource is RRC reconfigured, the terminal receives an RRC reconfiguration message, and the terminal receives an updated System Information Block (SIB) message.

Herein, that the first transmission resource is RRC reconfigured may be understood as that the terminal receives an RRC message and releases the first transmission resource, that is, the transmission resource of the terminal does not include the first transmission resource, and the RRC message is, for example, RRC reconfiguration information or a SIB message. That the terminal receives the RRC reconfiguration message may be understood as that the terminal receives the RRC reconfiguration message, that is, confirms that the second condition is met. That the terminal receives the updated SIB message may be understood as that the terminal receives an updated SIB message related to a sidelink configuration.

The first timer may be network-configured, pre-agreed, protocol-stipulated, or the like. The fourth value, the fifth value, the sixth value, and the seventh value may be configured by the network side device such as the base station, protocol-stipulated, or the like. This is not limited. If the first timer expires, it may be determined that the first transmission resource is recovered from the SL consistent LBT failure, or the SL consistent LBT failure is canceled for the first transmission resource.

In addition to the foregoing first timer, a second timer may be introduced in this embodiment to perform autonomous recovery when the SL consistent LBT failure is triggered on all transmission resources in a transmission resource with a larger granularity. The second timer may be network-configured, pre-agreed, protocol-stipulated, or the like.

In some embodiments, the determining that an SL consistent LBT failure is triggered on a first transmission resource includes: determining that the SL consistent LBT failure is triggered on all first transmission resources in a sixth transmission resource, where a granularity of the sixth transmission resource is greater than the granularity of the first transmission resource, and for example, the granularity of the sixth transmission resource is a resource pool, and the granularity of the first transmission resource is an RB set.

The performing autonomous recovery for the first transmission resource may include:

The terminal starts a second timer, and performs a second operation, where the second operation includes any one of the following: (1) when the second timer is running, if a third condition is met, stopping the second timer, and determining that all the first transmission resources in the sixth transmission resource are recovered from the SL consistent LBT failure, or canceling the SL consistent LBT failure for all the first transmission resources in the sixth transmission resource, where the third condition includes at least one of the following: the terminal successfully performs sidelink SL transmission, a channel occupancy ratio of some or all of the first transmission resources in the sixth transmission resource is less than or equal to an eighth value, a resource occupancy ratio of some or all of the first transmission resources in the sixth transmission resource is less than or equal to a ninth value, a channel occupancy ratio of the sixth transmission resource is less than or equal to a tenth value, a resource occupancy ratio of the sixth transmission resource is less than or equal to an eleventh value, the terminal reports the second information to the network side device, the first transmission resource or the sixth transmission resource is RRC reconfigured, the terminal receives an RRC reconfiguration message, and the terminal receives an updated SIB message; and for example, the eighth value, the ninth value, the tenth value, and the eleventh value may be configured by the base station, pre-agreed, protocol-stipulated, or the like, and this is not limited; and (2) when the second timer expires, determining that all the first transmission resources in the sixth transmission resource are recovered from the SL consistent LBT failure, or canceling the SL consistent LBT failure for all the first transmission resources in the sixth transmission resource.

Herein, the second timer may be network-configured, pre-agreed, protocol-stipulated, or the like. That the first transmission resource or the sixth transmission resource is RRC reconfigured may be understood as that the terminal receives an RRC message and releases the first transmission resource or the sixth transmission resource, that is, the transmission resource of the terminal does not include the first transmission resource or the sixth transmission resource, and the RRC message is, for example, RRC reconfiguration information or a SIB message. That the terminal receives the RRC reconfiguration message may be understood as that the terminal receives the RRC reconfiguration message, that is, confirms that the second condition is met. That the terminal receives the updated SIB message may be understood as that the terminal receives an updated SIB message related to a sidelink configuration.

In some embodiments, the performing autonomous recovery for the first transmission resource may include:

When a fourth condition is met, the terminal determines that the first transmission resource is recovered from the SL consistent LBT failure, or cancels the SL consistent LBT failure for the first transmission resource, where the fourth condition includes at least one of the following: the terminal successfully performs sidelink transmission by using any transmission resource in a seventh transmission resource that includes the first transmission resource, and the terminal successfully performs sidelink transmission by using a transmission resource in an eighth transmission resource that does not include the first transmission resource. In other words, when it is determined that the SL consistent LBT failure is triggered on the first transmission resource, if the terminal successfully performs sidelink transmission, the terminal may determine that the first transmission resource is recovered from the SL consistent LBT failure, or cancel the SL consistent LBT failure for the first transmission resource.

FIG. 3 is a flowchart of an information configuration method according to an embodiment of this application. The method is performed by a network device. As shown in FIG. 3, the method includes the following steps.

Step 31: The network side device sends configuration information to a terminal.

Herein, the configuration information may include at least one of the following: first configuration information, where the first configuration information indicates whether the terminal reports, to the network side device when an SL consistent LBT failure is triggered, information used to indicate a transmission resource on which the SL consistent LBT failure is triggered; second configuration information, where the second configuration information indicates the terminal to determine whether to report, to the network side device based on a first condition when the SL consistent LBT failure is triggered, information used to indicate a transmission resource on which the SL consistent LBT failure is triggered; the first condition includes at least one of the following: a quantity of transmission resources on which the SL consistent LBT failure is triggered is greater than or equal to a first value, a quantity of transmission resources on which the SL consistent LBT failure is triggered in a second transmission resource is greater than or equal to a second value, and a first ratio is greater than or equal to a third value; the first ratio is a ratio of a transmission resource on which the SL consistent LBT failure is triggered in a third transmission resource to all transmission resources in the third transmission resource; and the first value, the second value, and the third value may be configured by the network side device, pre-agreed, protocol-stipulated, or the like; and third configuration information, where the third configuration information indicates whether the terminal is allowed to report, to the network side device when the SL consistent LBT failure is triggered, information used to indicate a transmission resource on which the SL consistent LBT failure is triggered.

In this way, the configuration information is sent to the terminal, so that the terminal can determine whether to report the information used to indicate the transmission resource on which the SL consistent LBT failure is triggered.

For example, assuming that a UE receives first configuration information of a base station, where the first configuration information indicates whether the UE reports, to the base station when the SL consistent LBT failure is triggered, a MAC CE used to indicate a transmission resource on which the SL consistent LBT failure is triggered, when the UE determines/judges that the SL consistent LBT failure is triggered on the first transmission resource, if the first configuration information indicates the UE to report, to the base station when the SL consistent LBT failure is triggered, the MAC CE used to indicate the transmission resource on which the SL consistent LBT failure is triggered, the UE reports a first MAC CE to the base station; or if the first configuration information indicates the UE not to report, to the base station when the SL consistent LBT failure is triggered, the MAC CE used to indicate the transmission resource on which the SL consistent LBT failure is triggered, the UE does not report the first MAC CE to the base station; and the first MAC CE indicates the first transmission resource on which the SL consistent LBT failure is triggered. In addition, if the UE does not receive the first configuration information of the base station, when determining/conforming that the SL consistent LBT failure is triggered on the first transmission resource, the UE does not report the first MAC CE to the base station.

For another example, assuming that the UE receives second configuration information of the base station, where the second configuration information indicates the UE to report, to the base station based on the first condition when the SL consistent LBT failure is triggered, a MAC CE used to indicate a transmission resource on which the SL consistent LBT failure is triggered, when the UE determines/judges that the SL consistent LBT failure is triggered on the first transmission resource, if the first condition is met, the UE reports the first MAC CE to the base station; or if the first condition is not met, the UE does not report the first MAC CE to the base station; and the first MAC CE indicates the first transmission resource on which the SL consistent LBT failure is triggered. In addition, if the UE does not receive the second configuration information of the base station, when determining/conforming that the SL consistent LBT failure is triggered on the first transmission resource, the UE does not report the first MAC CE to the base station.

For another example, assuming that the UE receives third configuration information of the base station, where the third configuration information indicates whether the UE is allowed to/may report, to the base station when the SL consistent LBT failure is triggered, a MAC CE used to indicate a transmission resource on which the SL consistent LBT failure is triggered, when the UE determines/judges that the SL consistent LBT failure is triggered on the first transmission resource, if the third configuration information indicates that the UE is allowed to/may report, to the base station when the SL consistent LBT failure is triggered, the MAC CE used to indicate the transmission resource on which the SL consistent LBT failure is triggered, the UE decide, based on an implementation of the UE, to report a first MAC CE to the base station; or if the third configuration information indicates that the UE is not allowed to/may not report, to the base station when the SL consistent LBT failure is triggered, the MAC CE used to indicate the transmission resource on which the SL consistent LBT failure is triggered, the UE does not report the first MAC CE to the base station; and the first MAC CE indicates the first transmission resource on which the SL consistent LBT failure is triggered. In addition, if the UE does not receive the third configuration information of the base station, when determining/conforming that the SL consistent LBT failure is triggered on the first transmission resource, the UE does not report the first MAC CE to the base station.

In a related technology, to reduce a quantity of times of performing LBT, the UE or the base station may perform transmission by using resources (for example, slot resources) consecutive in time domain. For example, when the UE performs transmission by using two inconsecutive slots in time domain, the UE needs to perform LBT twice. When the UE performs transmission by using two consecutive slots in time domain, if the UE successfully performs LBT for the first slot, the UE does not need to perform LBT for the second slot, but may continue to perform transmission from the first slot. Slot resources consecutive in time domain may be referred to as Multi-Consecutive Slot transmission (MCSt) resources.

For a single-slot transmission resource, when LBT fails to be performed for the single-slot resource, resource reselection may be performed. However, when LBT fails to be performed for a resource of one or more slots in an MCSt resource, whether resource reselection needs to be performed and when resource reselection is performed are not clearly specified in a related technology.

A technical solution is as follows: When the UE fails to perform LBT for the resource of the one or more slots in the MCSt resource, the UE does not perform resource reselection for any LBT failure. Another technical solution is as follows: The UE performs resource reselection for transmission processes or transport blocks TBs associated with all slot resources only when LBT fails to be performed for all the slot resources in the MCSt resource. The two technical solutions have the following disadvantage: If LBT fails to be performed for a slot resource earlier in the MCSt resource, the UE cannot perform resource reselection in time for a transmission process or a TB associated with the slot resource, which causes an additional transmission delay.

In view of the foregoing disadvantage, an SL COT sharing technology is considered (which means that one UE may share unused duration of a channel preempted by the type1 LBT with another UE, so that the another UE can use the type2 LBT with a high channel access success rate to try to preempt the channel). In this application, it is proposed that in the MCSt resource, for an SL grant, if an LBT failure occurs on a current transmission opportunity of the UE, but there is still a remaining retransmission opportunity in the MCSt resource, the UE does not perform resource reselection for the current transmission opportunity; or if there is still a remaining retransmission opportunity in the MCSt resource, the UE does not perform resource re-evaluation /resource pre-emption for the current transmission opportunity.

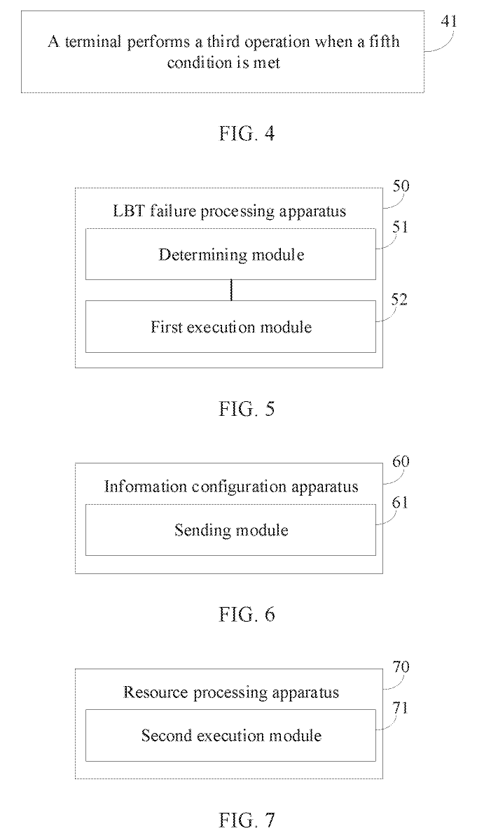

FIG. 4 is a flowchart of a resource processing method according to an embodiment of this application. The method is performed by a terminal. As shown in FIG. 4, the method includes the following steps.

Step 41: The terminal performs a third operation when a fifth condition is met.

In this embodiment, the fifth condition may include at least one of the following: a ninth transmission resource is a resource included in an MCSt resource, and the MCSt resource does not include a retransmission opportunity of transmission associated with the ninth transmission resource; a ninth transmission resource is a resource included in a tenth transmission resource, the ninth transmission resource and the tenth transmission resource are resources in a same channel occupancy time COT period, and the tenth transmission resource does not include a retransmission opportunity of transmission associated with the ninth transmission resource, where herein, that the ninth transmission resource and the tenth transmission resource are resources in a same channel occupancy time COT period may be understood as that in time domain, the ninth transmission resource and the tenth transmission resource are located in maximum transmission duration that can be occupied after the terminal successfully accesses a process by using a same type1 LBT channel; a ninth transmission resource is a resource included in an MCSt resource, and a remaining transmission resource in the MCSt resource does not include a retransmission opportunity of transmission associated with the ninth transmission resource, where herein, a remaining transmission resource represents a resource for which LBT has not been performed; and a ninth transmission resource is a resource included in a tenth transmission resource, the ninth transmission resource and the tenth transmission resource are resources in a same channel occupancy time COT period, and a remaining transmission resource in the tenth transmission resource does not include a retransmission opportunity of transmission associated with the ninth transmission resource, where herein, a remaining transmission resource represents a resource for which LBT has not been performed.

The third operation may include at least one of the following: performing resource reselection for an LBT failure of transmission associated with the ninth transmission resource; not sending third information from a PHY layer to a MAC layer, where the third information indicates to perform re-evaluation or resource pre-emption for the ninth transmission resource; ignoring, at the MAC layer, fourth information sent by the PHY layer, where the fourth information indicates to perform re-evaluation or pre-emption for the ninth transmission resource; and not performing re-evaluation check or pre-emption check for the ninth transmission resource at the MAC layer.

It may be understood that the terminal does not perform the third operation if the fifth condition is not met.

In this way, it may be ensured that resource reselection is performed in time for a resource for which LBT fails to be performed, thereby reducing a transmission delay.

The LBT failure processing method provided in the embodiments of this application may be performed by an LBT failure processing method apparatus. In the embodiments of this application, an example in which the LBT failure processing apparatus performs the LBT failure processing method is used to describe the LBT failure processing apparatus provided in the embodiments of this application.

FIG. 5 is a schematic diagram of a structure of an LBT failure processing apparatus according to an embodiment of this application. The apparatus is used in a terminal. As shown in FIG. 5, the LBT failure processing apparatus 50 includes: a determining module 51, configured to determine that an SL consistent LBT failure is triggered on a first transmission resource; and a first execution module 52, configured to perform a first operation, where the first operation includes at least one of the following: sending first information from a medium access control MAC layer to a physical PHY layer, where the first information indicates information about the first transmission resource; reporting second information to a network side device, or not reporting the second information to the network side device, where the second information indicates the first transmission resource on which the SL consistent LBT failure is triggered; and performing autonomous recovery for the first transmission resource.

In some embodiments, the first execution module 52 is configured to perform at least one of the following: when the terminal triggers resource selection or reselection, sending the first information from the MAC layer to the PHY layer; and sending the first information from the MAC layer to the PHY layer for each resource selection process or resource reselection process.

In some embodiments, the LBT failure processing apparatus 50 further includes: a receiving module, configured to receive configuration information, where the configuration information includes at least one of the following: first configuration information, where the first configuration information indicates whether the terminal reports, to the network side device when the SL consistent LBT failure is triggered, information used to indicate a transmission resource on which the SL consistent LBT failure is triggered; second configuration information, where the second configuration information indicates the terminal to report, to the network side device based on a first condition when the SL consistent LBT failure is triggered, information used to indicate a transmission resource on which the SL consistent LBT failure is triggered; the first condition includes at least one of the following: a quantity of transmission resources on which the SL consistent LBT failure is triggered is greater than or equal to a first value, a quantity of transmission resources on which the SL consistent LBT failure is triggered in a second transmission resource is greater than or equal to a second value, and a first ratio is greater than or equal to a third value; and the first ratio is a ratio of a transmission resource on which the SL consistent LBT failure is triggered in a third transmission resource to all transmission resources in the third transmission resource; and third configuration information, where the third configuration information indicates whether the terminal is allowed to report, to the network side device when the SL consistent LBT failure is triggered, information used to indicate a transmission resource on which the SL consistent LBT failure is triggered.

In some embodiments, when the configuration information includes the first configuration information, the first execution module 52 is configured to: report the second information to the network side device when the first configuration information indicates the terminal to report, to the network side device when the SL consistent LBT failure is triggered, the information used to indicate the transmission resource on which the SL consistent LBT failure is triggered; or not report the second information to the network side device when the first configuration information indicates the terminal to not report, to the network side device when the SL consistent LBT failure is triggered, the information used to indicate the transmission resource on which the SL consistent LBT failure is triggered.

In some embodiments, when the configuration information includes the second information, the first execution module 52 is configured to: report the second information to the network side device when the first transmission resource meets the first condition; or not report the second information to the network side device when the first transmission resource does not meet the first condition.

In some embodiments, when the configuration information includes the third information, the first execution module 52 is configured to: report, based on an implementation of the first execution module, the second information to the network side device, or not report the second information to the network side device when the third configuration information indicates that the terminal is allowed to report, to the network side device when the SL consistent LBT failure is triggered, the information used to indicate the transmission resource on which the SL consistent LBT failure is triggered; or not report the second information to the network side device when the third configuration information indicates that the terminal is not allowed to report, to the network side device when the SL consistent LBT failure is triggered, the information used to indicate the transmission resource on which the SL consistent LBT failure is triggered.

In some embodiments, the first execution module 52 is configured to: not report the second information to the network side device when the terminal does not receive the configuration information.

In some embodiments, the first execution module 52 is configured to: start a first timer; and when the first timer is running, if a second condition is met, stop the first timer, and determine that the first transmission resource is recovered from the SL consistent LBT failure, or cancel the SL consistent LBT failure for the first transmission resource, where the second condition includes at least one of the following: the terminal successfully performs sidelink transmission, a channel occupancy ratio of the first transmission resource is less than or equal to a fourth value, a resource occupancy ratio of the first transmission resource is less than or equal to a fifth value, a channel occupancy ratio of a fourth transmission resource that includes the first transmission resource is less than or equal to a sixth value, a resource occupancy ratio of a fifth transmission resource that includes the first transmission resource is less than or equal to a seventh value, the terminal reports the second information to the network side device, the first transmission resource is RRC reconfigured, the terminal receives an RRC reconfiguration message, and the terminal receives an updated SIB message.

In some embodiments, the determining module 51 is configured to determine that the SL consistent LBT failure is triggered on all first transmission resources in a sixth transmission resource; and the first execution module 52 is configured to: start a second timer, and perform a second operation, where the second operation includes any one of the following: when the second timer is running, if a third condition is met, stopping the second timer, and determining that all the first transmission resources in the sixth transmission resource are recovered from the SL consistent LBT failure, or canceling the SL consistent LBT failure for all the first transmission resources in the sixth transmission resource, where the third condition includes at least one of the following: the terminal successfully performs sidelink transmission, a channel occupancy ratio of some or all of the first transmission resources in the sixth transmission resource is less than or equal to an eighth value, a resource occupancy ratio of some or all of the first transmission resources in the sixth transmission resource is less than or equal to a ninth value, a channel occupancy ratio of the sixth transmission resource is less than or equal to a tenth value, a resource occupancy ratio of the sixth transmission resource is less than or equal to an eleventh value, the terminal reports the second information to the network side device, the first transmission resource or the sixth transmission resource is RRC reconfigured, the terminal receives an RRC reconfiguration message, and the terminal receives an updated SIB message; and when the second timer expires, determining that all the first transmission resources in the sixth transmission resource are recovered from the SL consistent LBT failure, or canceling the SL consistent LBT failure for all the first transmission resources in the sixth transmission resource.

In some embodiments, the first execution module 52 is configured to: when a fourth condition is met, determine that the first transmission resource is recovered from the SL consistent LBT failure, or cancel the SL consistent LBT failure for the first transmission resource, where the fourth condition includes at least one of the following: the terminal successfully performs sidelink transmission by using any transmission resource in a seventh transmission resource that includes the first transmission resource, and the terminal successfully performs sidelink transmission by using a transmission resource in an eighth transmission resource that does not include the first transmission resource.

The LBT failure processing apparatus 50 in this embodiment of this application may be an electronic device, for example, an electronic device with an operating system, or may be a component, for example, an integrated circuit or a chip, in the electronic device. The electronic device may be a terminal, or another device that is not the terminal. For example, the terminal may include but is not limited to the foregoing listed types of the terminal 11, and the another device may be a server, a Network Attached Storage (NAS), or the like. This is not limited in this embodiment of this application.

The LBT failure processing apparatus 50 provided in this embodiment of this application can implement the processes implemented in the method embodiment shown in FIG. 2, and achieve same technical effect. To avoid repetition, details are not described herein again.

FIG. 6 is a schematic diagram of a structure of an information configuration apparatus according to an embodiment of this application. The apparatus is used in a network side device. As shown in FIG. 6, the information configuration apparatus 60 includes: a sending module 61, configured to send configuration information to a terminal, where the configuration information includes at least one of the following: first configuration information, where the first configuration information indicates whether the terminal reports, to the network side device when an SL consistent LBT failure is triggered, information used to indicate a transmission resource on which the SL consistent LBT failure is triggered; second configuration information, where the second configuration information indicates the terminal to report, to the network side device based on a first condition when the SL consistent LBT failure is triggered, information used to indicate a transmission resource on which the SL consistent LBT failure is triggered; the first condition includes at least one of the following: a quantity of transmission resources on which the SL consistent LBT failure is triggered is greater than or equal to a first value, a quantity of transmission resources on which the SL consistent LBT failure is triggered in a second transmission resource is greater than or equal to a second value, and a first ratio is greater than or equal to a third value; and the first ratio is a ratio of a transmission resource on which the SL consistent LBT failure is triggered in a third transmission resource to all transmission resources in the third transmission resource; and third configuration information, where the third configuration information indicates whether the terminal is allowed to report, to the network side device when the SL consistent LBT failure is triggered, information used to indicate a transmission resource on which the SL consistent LBT failure is triggered.

The information configuration apparatus 60 provided in this embodiment of this application can implement the processes implemented in the method embodiment shown in FIG. 3, and achieve same technical effect. To avoid repetition, details are not described herein again.

FIG. 7 is a schematic diagram of a structure of a resource processing apparatus according to an embodiment of this application. The apparatus is used in a terminal. As shown in FIG. 7, the resource processing apparatus 70 includes: a second execution module 72, configured to perform a third operation when a fifth condition is met, where the fifth condition includes at least one of the following: a ninth transmission resource is a resource included in an MCSt resource, and the MCSt resource does not include a retransmission opportunity of transmission associated with the ninth transmission resource; a ninth transmission resource is a resource included in a tenth transmission resource, the ninth transmission resource and the tenth transmission resource are resources in a same channel occupancy time period, and the tenth transmission resource does not include a retransmission opportunity of transmission associated with the ninth transmission resource; a ninth transmission resource is a resource included in an MCSt resource, and a remaining transmission resource in the MCSt resource does not include a retransmission opportunity of transmission associated with the ninth transmission resource; and a ninth transmission resource is a resource included in a tenth transmission resource, the ninth transmission resource and the tenth transmission resource are resources in a same channel occupancy time period, and a remaining transmission resource in the tenth transmission resource does not include a retransmission opportunity of transmission associated with the ninth transmission resource; and the third operation includes at least one of the following: performing resource reselection for an LBT failure of transmission associated with the ninth transmission resource; not sending third information from a PHY layer to a MAC layer, where the third information indicates to perform resource re-evaluation or resource pre-emption for the ninth transmission resource; ignoring, at the MAC layer, fourth information sent by the PHY layer, where the fourth information indicates to perform re-evaluation or pre-emption for the ninth transmission resource; and not performing re-evaluation check or pre-emption check for the ninth transmission resource at the MAC layer.

The resource processing apparatus 70 provided in this embodiment of this application can implement the processes implemented in the method embodiment shown in FIG. 4, and achieve same technical effect. To avoid repetition, details are not described herein again.

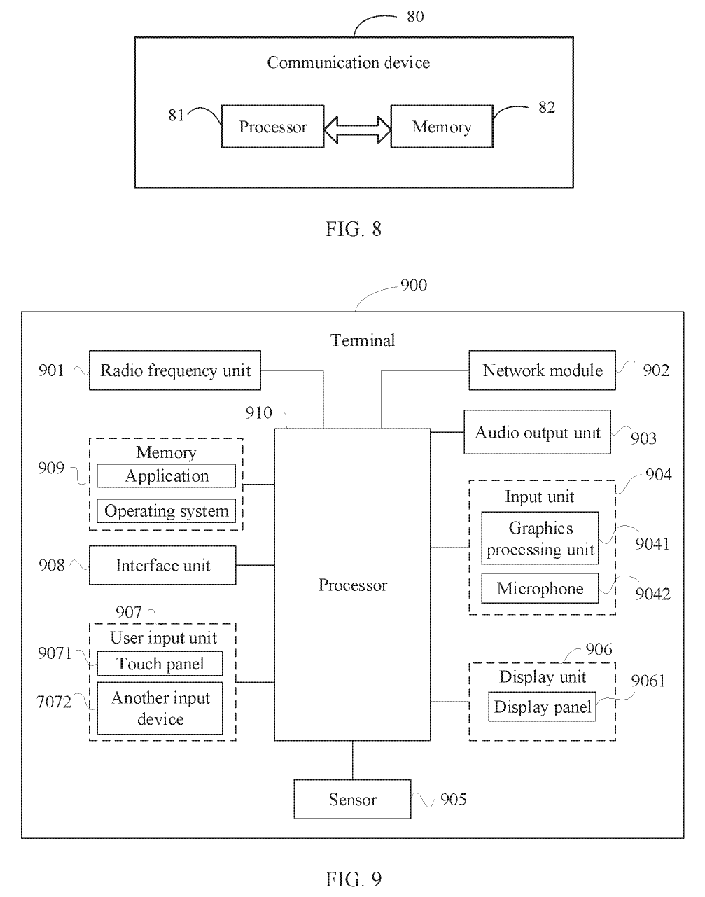

As shown in FIG. 8, an embodiment of this application further provides a communication device 80. The communication device 80 includes a processor 81 and a memory 82. The memory 82 stores a program or an instruction that can be run on the processor 81. For example, when the communication device 80 is a terminal, and the program or the instruction is executed by the processor 81, the steps of the embodiment of the foregoing LBT failure processing method may be implemented, or the steps of the embodiment of the foregoing resource processing method may be implemented, and same technical effect can be achieved. When the communication device 80 is a network side device, and the program or the instruction is executed by the processor 81, the steps of the embodiment of the foregoing information configuration method may be implemented, and same technical effect can be achieved. To avoid repetition, details are not described herein again.

An embodiment of this application further provides a terminal. The terminal includes a processor and a communication interface, the communication interface is coupled to the processor, and the processor is configured to run a program or an instruction, to implement the steps of the method embodiment shown in FIG. 2 or FIG. 4. The terminal embodiment corresponds to the method embodiment on the terminal side, each implementation process and implementation of the method embodiment can be applied to the terminal embodiment, and same technical effect can be achieved.

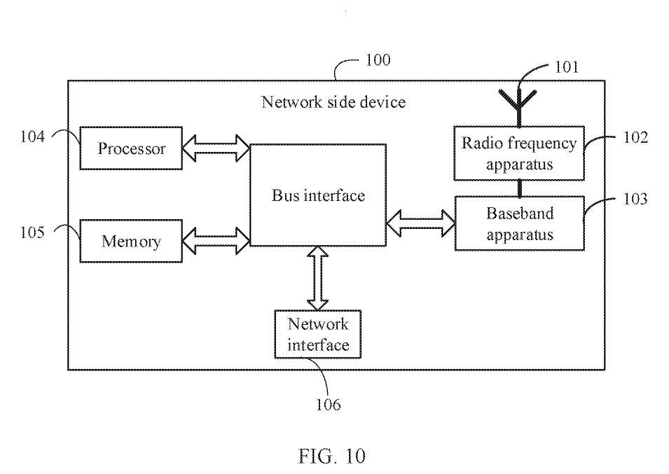

For example, FIG. 9 is a schematic diagram of a hardware structure of a terminal according to an embodiment of this application.

The terminal 900 includes but is not limited to at least a part of components such as a radio frequency unit 901, a network module 902, an audio output unit 903, an input unit 904, a sensor 905, a display unit 906, a user input unit 907, an interface unit 908, a memory 909, and a processor 910.

A person skilled in the art can understand that the terminal 900 may further include a power supply (such as a battery) that supplies power to each component. The power supply may be logically connected to the processor 910 by using a power supply management system, to implement functions such as charging and discharging management, and power consumption management by using the power supply management system. The terminal structure shown in FIG. 9 constitutes no limitation on the terminal, and the terminal may include more or fewer components than those shown in the figure, or combine some components, or have different component arrangements. Details are not described herein.

It should be understood that in this embodiment of this application, the input unit 904 may include a Graphics Processing Unit (GPU) 9041 and a microphone 9042. The graphics processing unit 9041 processes image data of a static picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 901 may transmit the downlink data to the processor 910 for processing. In addition, the radio frequency unit 901 may send uplink data to the network side device. Usually, the radio frequency unit 901 includes but is not limited to an antenna, an amplifier, a transceiver, a coupler, a low noise amplifier, a duplexer, and the like.

The memory 909 may be configured to store a software program or an instruction and various data. The memory 909 may mainly include a first storage area for storing a program or an instruction and a second storage area for storing data. The first storage area may store an operating system, and an application or an instruction required by at least one function (for example, a sound playing function or an image playing function). In addition, the memory 909 may include a volatile memory or a nonvolatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 909 in this embodiment of this application includes but is not limited to these memories and any memory of another proper type.

The processor 910 may include one or more processing units. In some embodiments, an application processor and a modem processor are integrated into the processor 910. The application processor mainly processes an operating system, a user interface, an application, and the like. The modem processor mainly processes a wireless communication signal, for example, a baseband processor. It may be understood that the modem processor may not be integrated into the processor 910.

The processor 910 is configured to: determine that an SL consistent LBT failure is triggered on a first transmission resource; and perform a first operation, where the first operation includes at least one of the following: sending first information from a MAC layer to a PHY layer, where the first information indicates information about the first transmission resource; reporting second information to a network side device, or not reporting the second information to the network side device, where the second information indicates the first transmission resource on which the SL consistent LBT failure is triggered; and performing autonomous recovery for the first transmission resource.

It may be understood that for an implementation process of the implementations in this embodiment, refer to related descriptions of the method embodiment shown in FIG. 2 or FIG. 4, and same or corresponding technical effect may be achieved. To avoid repetition, details are not described herein again.

An embodiment of this application further provides a network side device. The network side device includes a processor and a communication interface, the communication interface is coupled to the processor, and the processor is configured to run a program or an instruction, to implement the steps of the method embodiment shown in FIG. 3. The network side device embodiment corresponds to the foregoing method embodiment of the network side device, each implementation process and implementation of the foregoing method embodiment can be applied to the network side device embodiment, and same technical effect can be achieved.

An embodiment of this application further provides a network side device. As shown in FIG. 10, the network side device 100 includes an antenna 101, a radio frequency apparatus 102, a baseband apparatus 103, a processor 104, and a memory 105. The antenna 101 is connected to the radio frequency apparatus 102. In an uplink direction, the radio frequency apparatus 102 receives information through the antenna 101, and sends the received information to the baseband apparatus 103 for processing. In a downlink direction, the baseband apparatus 103 processes information that needs to be sent, and sends processed information to the radio frequency apparatus 102. The radio frequency apparatus 102 processes the received information, and sends processed information through the antenna 101.

In the foregoing embodiment, the method performed by the network side device may be implemented in the baseband apparatus 103. The baseband apparatus 103 includes a baseband processor.

For example, the baseband apparatus 103 may include at least one baseband board. A plurality of chips are disposed on the baseband board. As shown in FIG. 10, one chip is, for example, a baseband processor, and is connected to the memory 105 through a bus interface, to invoke a program in the memory 105 to perform the operations of the network device shown in the foregoing method embodiment.

The network side device may further include a network interface 106, and the interface is, for example, a Common Public Radio Interface (CPRI).

The network side device 100 in this embodiment of this application further includes an instruction or a program that is stored in the memory 105 and that can be run on the processor 104. The processor 104 invokes the instruction or the program in the memory 105 to perform the method performed by the modules shown in FIG. 6, and same technical effect is achieved. To avoid repetition, details are not described herein again.

An embodiment of this application further provides a readable storage medium. The readable storage medium stores a program or an instruction. When the program or the instruction is executed by a processor, the processes of the embodiment of the foregoing LBT failure processing method are implemented, or the processes of the embodiment of the foregoing information configuration method are implemented, or the processes of the embodiment of the foregoing resource processing method are implemented, and same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface. The communication interface is coupled to the processor. The processor is configured to run a program or an instruction, to implement the processes of the embodiment of the foregoing LBT failure processing method, or implement the processes of the embodiment of the foregoing information configuration method, or implement the processes of the embodiment of the foregoing resource processing method, and same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor, to implement the processes of the embodiment of the foregoing LBT failure processing method, or implement the processes of the embodiment of the foregoing information configuration method, or implement the processes of the embodiment of the foregoing resource processing method, and same technical effect can be achieved. To avoid repetition, details are not described herein again.

An embodiment of this application further provides a wireless communication system. The wireless communication system includes a terminal and a network side device. The terminal may be configured to perform the steps of the foregoing LBT failure processing method or the foregoing resource processing method, and the network side device may be configured to perform the steps of the foregoing information configuration method.

It should be noted that, in this specification, the term "include", "comprise", or any other variant thereof is intended to cover a non-exclusive inclusion, so that a process, a method, an article, or an apparatus that includes a list of elements not only includes those elements but also includes other elements that are not expressly listed, or further includes elements inherent to this process, method, article, or apparatus. In absence of more constraints, an element preceded by "includes a..." does not preclude the existence of other identical elements in the process, method, article, or apparatus that includes the element. In addition, it should be noted that the scope of the method and apparatus in the embodiments of this application is not limited to performing functions in the order shown or discussed, but may also include performing the functions in a basically simultaneous manner or in opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiments may be implemented by using a computer software product in addition to a necessary universal hardware platform, or may be implemented by hardware. The computer software product is stored in a storage medium (such as a ROM, a RAM, a magnetic disk, or an optical disc), and includes several instructions for instructing a terminal or a network side device to perform the method described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms of implementations without departing from the purpose of this application and the protection scope of the claims, all of the implementations fall within the protection of this application.

1. A Listen Before Talk (LBT) failure processing method, comprising:
determining, by a terminal, that a Sidelink (SL) consistent LBT failure is triggered on a first transmission resource; and
performing, by the terminal, a first operation, wherein the first operation comprises at least one of the following:
sending first information from a Medium Access Control (MAC) layer to a Physical (PHY) layer, wherein the first information indicates information about the first transmission resource,
reporting second information to a network side device, or not reporting the second information to the network side device, wherein the second information indicates the first transmission resource on which the SL consistent LBT failure is triggered, or
performing autonomous recovery for the first transmission resource.

2. The LBT failure processing method according to claim 1, wherein sending the first information from the MAC layer to the PHY layer comprises at least one of the following:
when the terminal triggers resource selection or reselection, sending the first information from the MAC layer to the PHY layer; or
sending the first information from the MAC layer to the PHY layer for each resource selection process or resource reselection process.

3. The LBT failure processing method according to claim 1, further comprising:
receiving, by the terminal, configuration information, wherein the configuration information comprises at least one of the following:
first configuration information, wherein the first configuration information indicates whether the terminal reports, to the network side device when the SL consistent LBT failure is triggered, information used to indicate a transmission resource on which the SL consistent LBT failure is triggered;
second configuration information,
wherein:
the second configuration information indicates the terminal to report, to the network side device based on a first condition when the SL consistent LBT failure is triggered, information used to indicate a transmission resource on which the SL consistent LBT failure is triggered;
the first condition comprises at least one of the following:
a quantity of transmission resources on which the SL consistent LBT failure is triggered is greater than or equal to a first value,
a quantity of transmission resources on which the SL consistent LBT failure is triggered in a second transmission resource is greater than or equal to a second value, or
a first ratio is greater than or equal to a third value; and
the first ratio is a ratio of a transmission resource on which the SL consistent LBT failure is triggered in a third transmission resource to all transmission resources in the third transmission resource; or
third configuration information, wherein the third configuration information indicates whether the terminal is allowed to report, to the network side device when the SL consistent LBT failure is triggered, information used to indicate a transmission resource on which the SL consistent LBT failure is triggered.

4. The LBT failure processing method according to claim 3, wherein when the configuration information comprises the first configuration information, the reporting second information to a network side device, or not reporting the second information to the network side device comprises:
reporting, by the terminal, the second information to the network side device when the first configuration information indicates the terminal to report, to the network side device when the SL consistent LBT failure is triggered, the information used to indicate the transmission resource on which the SL consistent LBT failure is triggered; or
not reporting, by the terminal, the second information to the network side device when the first configuration information indicates the terminal to not report, to the network side device when the SL consistent LBT failure is triggered, the information used to indicate the transmission resource on which the SL consistent LBT failure is triggered.

5. The LBT failure processing method according to claim 3, wherein when the configuration information comprises the second configuration information, the reporting second information to a network side device, or not reporting the second information to the network side device comprises:
reporting, by the terminal, the second information to the network side device when the first transmission resource meets the first condition; or
not reporting, by the terminal, the second information to the network side device when the first transmission resource does not meet the first condition.

6. The LBT failure processing method according to claim 3, wherein when the configuration information comprises the third configuration information, the reporting second information to a network side device, or not reporting the second information to the network side device comprises:
reporting, by the terminal based on an implementation of the terminal, the second information to the network side device, or not reporting the second information to the network side device when the third configuration information indicates that the terminal is allowed to report, to the network side device when the SL consistent LBT failure is triggered, the information used to indicate the transmission resource on which the SL consistent LBT failure is triggered; or
not reporting, by the terminal, the second information to the network side device when the third configuration information indicates that the terminal is not allowed to report, to the network side device when the SL consistent LBT failure is triggered, the information used to indicate the transmission resource on which the SL consistent LBT failure is triggered.

7. The LBT failure processing method according to claim 3, wherein the not reporting the second information to the network side device comprises: not reporting, by the terminal, the second information to the network side device when the terminal does not receive the configuration information.

8. The LBT failure processing method according to claim 1, wherein performing the autonomous recovery for the first transmission resource comprises:
starting, by the terminal, a first timer; and
when the first timer is running, when a second condition is met, stopping, by the terminal, the first timer, and determining that the first transmission resource is recovered from the SL consistent LBT failure, or canceling the SL consistent LBT failure for the first transmission resource,
wherein the second condition comprises at least one of the following:
the terminal successfully performs sidelink transmission,
a channel occupancy ratio of the first transmission resource is less than or equal to a fourth value,
a resource occupancy ratio of the first transmission resource is less than or equal to a fifth value,
a channel occupancy ratio of a fourth transmission resource that comprises the first transmission resource is less than or equal to a sixth value,
a resource occupancy ratio of a fifth transmission resource that comprises the first transmission resource is less than or equal to a seventh value,
the terminal reports the second information to the network side device,
the first transmission resource is radio resource control RRC reconfigured,
the terminal receives an RRC reconfiguration message, or
the terminal receives an updated system information block SIB message.

9. The LBT failure processing method according to claim 1, wherein determining that the SL consistent LBT failure is triggered on a first transmission resource comprises:
determining, by the terminal, that the SL consistent LBT failure is triggered on all first transmission resources in a sixth transmission resource; and
performing the autonomous recovery for the first transmission resource comprises:
starting, by the terminal, a second timer, and performing a second operation,
wherein the second operation comprises any one of the following:
when the second timer is running, when a third condition is met, stopping the second timer, and determining that all the first transmission resources in the sixth transmission resource are recovered from the SL consistent LBT failure, or canceling the SL consistent LBT failure for all the first transmission resources in the sixth transmission resource,
wherein the third condition comprises at least one of the following:
the terminal successfully performs sidelink transmission,
a channel occupancy ratio of some or all of the first transmission resources in the sixth transmission resource is less than or equal to an eighth value,
a resource occupancy ratio of some or all of the first transmission resources in the sixth transmission resource is less than or equal to a ninth value,
a channel occupancy ratio of the sixth transmission resource is less than or equal to a tenth value,
a resource occupancy ratio of the sixth transmission resource is less than or equal to an eleventh value,
the terminal reports the second information to the network side device,
the first transmission resource or the sixth transmission resource is RRC reconfigured,
the terminal receives an RRC reconfiguration message, or
the terminal receives an updated SIB message; or
when the second timer expires, determining that all the first transmission resources in the sixth transmission resource are recovered from the SL consistent LBT failure, or canceling the SL consistent LBT failure for all the first transmission resources in the sixth transmission resource.

10. The LBT failure processing method according to claim 1, wherein performing the autonomous recovery for the first transmission resource comprises:
when a fourth condition is met, determining, by the terminal, that the first transmission resource is recovered from the SL consistent LBT failure, or canceling the SL consistent LBT failure for the first transmission resource, wherein
the fourth condition comprises at least one of the following:
the terminal successfully performs sidelink transmission by using any transmission resource in a seventh transmission resource that comprises the first transmission resource, or
the terminal successfully performs sidelink transmission by using a transmission resource in an eighth transmission resource that does not comprise the first transmission resource.

11. An information configuration method, comprising:
sending, by a network side device, configuration information to a terminal, wherein the configuration information comprises at least one of the following:
first configuration information, wherein the first configuration information indicates whether the terminal reports, to the network side device when a Sidelink (SL) consistent Listen Before Talk (LBT) failure is triggered, information used to indicate a transmission resource on which the SL consistent LBT failure is triggered;
second configuration information,
wherein:
the second configuration information indicates the terminal to report, to the network side device based on a first condition when the SL consistent LBT failure is triggered, information used to indicate a transmission resource on which the SL consistent LBT failure is triggered;
the first condition comprises at least one of the following:
a quantity of transmission resources on which the SL consistent LBT failure is triggered is greater than or equal to a first value,
a quantity of transmission resources on which the SL consistent LBT failure is triggered in a second transmission resource is greater than or equal to a second value, or
a first ratio is greater than or equal to a third value; and the first ratio is a ratio of a transmission resource on which the SL consistent LBT failure is triggered in a third transmission resource to all transmission resources in the third transmission resource; or
third configuration information, wherein the third configuration information indicates whether the terminal is allowed to report, to the network side device when the SL consistent LBT failure is triggered, information used to indicate a transmission resource on which the SL consistent LBT failure is triggered.

12. A resource processing method, comprising:
performing, by a terminal, a third operation when a fifth condition is met,
wherein:
the fifth condition comprises at least one of the following:
a ninth transmission resource is a resource comprised in a Multi-Consecutive Slot Transmission (MCSt) resource, and the MCSt resource does not comprise a retransmission opportunity of transmission associated with the ninth transmission resource;
a ninth transmission resource is a resource comprised in a tenth transmission resource, the ninth transmission resource and the tenth transmission resource are resources in a same channel occupancy time period, and the tenth transmission resource does not comprise a retransmission opportunity of transmission associated with the ninth transmission resource;
a ninth transmission resource is a resource comprised in an MCSt resource, and a remaining transmission resource in the MCSt resource does not comprise a retransmission opportunity of transmission associated with the ninth transmission resource; or
a ninth transmission resource is a resource comprised in a tenth transmission resource, the ninth transmission resource and the tenth transmission resource are resources in a same channel occupancy time period, and a remaining transmission resource in the tenth transmission resource does not comprise a retransmission opportunity of transmission associated with the ninth transmission resource; and
the third operation comprises at least one of the following:
performing resource reselection for a Listen Before Talk (LBT) failure of transmission associated with the ninth transmission resource;
not sending third information from a Physical (PHY) layer to a Medium Access Control (MAC) layer, wherein the third information indicates to perform resource re-evaluation or resource pre-emption for the ninth transmission resource;
ignoring, at the MAC layer, fourth information sent by the PHY layer, wherein the fourth information indicates to perform re-evaluation or pre-emption for the ninth transmission resource; or
not performing re-evaluation check or pre-emption check for the ninth transmission resource at the MAC layer.
